(19) United States
(12) Patent Application Publication
(10) Pub. No.: US 2025/0383906 A1
(43) Pub. Date: Dec. 18, 2025

(54) SYSTEMS AND METHODS FOR AUTOMATIC OFFLOADING TO EXTERNAL COMPUTING DEVICES

(71) Applicants: Constructor Technology AG, Schaffhausen (CH); Constructor Education and Research Genossenschaft, Schaffhausen (CH)

(72) Inventors: Alexey Koryakin, Zurich (CH); Alexander Tormasov, Kazan (RU); Serg Bell, Costa del Sol (SG); Stanislav Protasov, Singapore (SG); Nikolay Dobrovolskiy, Istanbul (TR); Laurent Dedenis, Singapore (SG)

(21) Appl. No.: 18/745,273

(22) Filed: Jun. 17, 2024

(51) Int. Cl. G06F 9/455

(52) U.S. Cl. CPC G06F 9/45558; G06F 2009/45595

(57) ABSTRACT

Methods and systems are disclosed for automatically obtaining a result of execution in a remote execution environment, such as high-performance computing cluster HPC, of elements of a version of a complex computational system relying on at least one data source. Configuration of the remote execution environment, as well as deployment of the version of the computational system and its configuration is performed automatically using instructions preserved within the version-tracking system. Intermediate statuses and the result of the execution are produced according to the instructions preserved within the version-tracking system and are preserved within the version-tracing system.

### TECHNICAL FIELD

The present disclosure is generally related to systems and methods of collaboration in data-intensive environments such as academic or commercial R&D organizations with large datasets, including complex computational systems that are dependent on the execution environment.

### BACKGROUND

A class of technologies exists in the modern world, specifically in the scientific and commercial R&D community, that relies on calculating a result using complex calculational methods based on large datasets. These technologies comprise a data component, a software component, and a computing environment component that may include high-capacity remote computing environments. Sometimes a need arises to reproduce previously obtained results or execute the system with a specific modification in precisely the same environment to be able to compare results in controlled experiment that excludes variations that may be caused by the differences in execution environment or data.

Therefore, systems and methods are needed to automatically configure a remote environment, deploy a version of a complex computational program to a remote environment, to configure the computational program to access the dataset, and to execute the elements of the computational program in a specific sequence.

### SUMMARY

A class of computer systems exists that is specifically designed to process large amounts of data and to produce a certain result. Normally, these systems are used in scientific or corporate research and development communities. These systems rely on data sources. These data sources are often hosted in a particular location and are too large to copy. The nature of the research requires that the same version of such a system repeatedly produces exactly the same result when executed on the same data set. This may be necessary, for example, to study how changes in data influence the outcome of a certain process, or to verify a certain scientific theory.

Most computer programs are created in such a way that they are specific to a particular version of an operating system. Even more, some of them rely on a particular configuration of an environment. The result of execution of a particular computer program may be different if it is executed in different environments, for example, using different versions of libraries it uses.

Some computational systems use a multi-step computation process, wherein the output of one step may be used as input for another step, while certain other steps may be run concurrently. A set of execution instructions may be developed that automates that process.

Execution of certain computation systems requires large amounts of computer resources and may only be performed within special-purpose remote computing environments, for example, high-performance computing (HPC) clusters. Other systems are developed for rare versions of operating systems and may require a virtual machine running that specific version of an operating system to be able to execute such a system.

Systems and methods preserve a set of instructions within a meta-version tracking system on configuring the remote computational environment, for example, virtual containers, deploying elements of the computational system to that environment, configuring the deployed components to be able to access a specific data source, as well as to communicate intermediate status and final result to the meta-version tracking system. When an instruction to execute a particular version of the computation system is received, the remote execution environment is configured according to saved instructions, certain elements of the version of the computational system are deployed to the remote execution environment according to the saved instructions, where these elements are configured and executed according to the saved instructions. Intermediate status, as well as the result of the execution are communicated back to the meta-version tracking system where the respective status and results are saved or displayed to the computer operator. In an embodiment, the container comprises a docker container as a lightweight, standalone, executable package of software that includes everything needed to run an application: code, runtime, system tools, system libraries and settings.

In an embodiment, a method of obtaining a result R of execution of a version V of a computational system CS on a remote computing environment RCE using instructions saved within a meta-version tracking system MVTS, wherein R comprises at least one numeric value, CS comprises a binary executable or a scripting file, RCE comprises at least one physical or virtual computer that comprises physical or virtualized computer hardware and an operating system comprises creating a record within the meta-version tracking system MVTS related to a version V; recording, in any order, in the meta-version tracking system MVTS related to the version V within the record: at least one configuration instruction for at least one element of the remote computing environment RCE, at least one deployment instruction for at least one element of the computational system CS to an execution environment EE, at least one configuration instruction for at least one element of the deployed computational system DSC to access at least one data source DS, at least one instruction to execute at least one element of a deployed computational system DSC in the remote computing environment RCE; receiving a command to deploy and execute the version V of the computational system CS to the remote computing environment RCE; modifying at least one element of the remote computing environment using at least one instruction saved in the meta-version tracking system MVTS related to the version V; copying at least one clement of the version V of the computational system CS to the remote computing environment RCE using at least one instruction saved in the meta-version tracking system MVTS related to the version V; configuring at least one element of the deployed computational system DCS to access at least one data source DS using at least one instruction saved in the meta-version tracking system MVTS related to the version V; executing using at least one instruction in the meta-version tracking system MVTS to execute at least one clement of the version V of the deployed computational system DSC in the remote computing environment RCE; receiving at the meta-version tracking system MVTS at least one intermediate status of execution of at least one element of the version V of the deployed computational system DSC and saving the at least one intermediate status within the meta-version tracking system MVTS or outputting the at least one intermediate status to an output device such as a computer screen; saving within the remote computing environment RCE at least one result R of the execution of at least one element of the version V of the deployed computational system DSC in the remote computing environment RCE; and transferring at least one result R from the remote computing environment to the meta-version tracking system and saving the at least one result R within the system to indicate that the at least one result R is related to the meta-version V of the computational system CS.

In an embodiment, a system of obtaining a result R of executing a version V of the computational system CS on a remote computing environment RCE using instructions saved within a meta-version tracking system MVTS comprising a meta-version tracking system configured to: create a record for the version V of the computational system VS; receive, save, and output: at least one configuration instruction for at least one element of the remote computing environment RCE, at least one deployment instruction for at least one element of the computational system CS to an execution environment EE, at least one configuration instruction for at least one element of a deployed computational system DSC to access at least one data source DS, at least one intermediate status of execution of at least one element of the version V of the computational system CS in the remote computing environment RCE, and at least one intermediate result R of execution of at least one element of the version V of the computational system CS in the remote computing environment RCE; a deployment module configured to: using at least one instruction from the meta-version tracking system MVTS, configure the remote computing environment RCE, using at least one instruction from the meta-version tracking system MVTS, deploy at least one component of the version V of the computation system CS to the remote computing environment RCE, and using at least one instruction from the meta-version tracking system MVTS, configure at least one element of the version V of the deployed computational system DCS to access at least one data source DS; and an execution module configured to: using at least one instruction from the meta-version tracking system MVTS, execute at least one element of the version V of the deployed computational system DSC in the remote computational environment, receive at least one intermediate status from at least one running element of the version V of the deployed computational system DCS and communicate the at least one intermediate status to the meta-version tracking system or output the at least one intermediate status to an output device such as a computer screen, and receive at least one result R from the execution of at least one element of the version V of the deployed computational system DCS and transfer the at least one result R to the meta-version tracking system MVTS.

Accordingly, embodiments allow for the automatic configuration, deployment, and execution of computational systems in identical environments thus excluding any external influences of the environment on the computational result.

### BRIEF DESCRIPTION OF DRAWINGS

Subject matter hereof may be more completely understood in consideration of the following detailed description of various embodiments in connection with the accompanying figures, in which:

FIG. 1 is a flowchart of a method of obtaining a result of execution of a version of a computational system on a remote computing environment, according to an embodiment.

FIG. 2 is a block diagram of a system for obtaining a result of execution of a version of a computational system on a remote computing environment, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure is generally related to systems and methods of developing, preserving and executing computational systems that take as input data sets and produce a result. These systems can be used by scientific or corporate research and development communities for the purpose of verifying the result of a complex computational process by recreating the result using an environment that is at least partially not under control of the party that produced the result that needs verification, for example, of DNA research or long-term weather analysis models. One of the requirements for such systems is to produce the same result when taking as input the same data source.

The result of execution of a particular calculating system may depend on multiple components, for example, hardware, type and version of the operating system, for example, Windows, Mac OS, or Linux, presence and versions of libraries or runtime environments, for example, Java Runtime Environment or Microsoft .NET Framework, particular versions of applications, either custom-built or commercial off the shelf (COTS), as well as type and contents of the data source, for example, the type of the database management system or format and composition of data.

One of the examples of differences between data sources are the differences in formats and data types adopted in different structured query languages (SQL), for example, T-SQL implemented by Microsoft in MS SQL server OR open-source variants PostgreSQL, MySQL, and SQLite. Differences between different implementations of the SQL language include case sensitivity, handling date/time objects and functions, usage of JOINs, and creating or adding data. In SQL variants, the LIMIT and TOP functions are used to select the first few entries from the desired query. However, TOP in T-SQL (MS SQL) unlike other SQL implementations can also find the TOP n PERCENT of results in a query.

Format, for example, representation of date/time values in different formats in text fields, and internal organization of data, for example, the fact that records are ordered by a certain element, may influence the result of execution of certain computational systems if they rely on that feature of the data to complete its execution. A computational system that uses such assumptions, may produce a different result or not be able to complete the execution process due to an error if the computational system uses data from a source that comprises data that does not reflect at least one of these assumptions.

Most computer programs are created for a particular version of an operating system. Some computer programs use third-party libraries. The results of execution of the same computer program in different operating systems with different versions of libraries may be different.

While some environments, such as high-performance computing clusters, offer a fixed version of an operating system, others, such as virtual machines, allow for selection of a variety of operating systems and their versions.

In an embodiment, a remote computing environment is a high-performance computing cluster, for example, a grid system comprising one or more grid nodes. A grid is a distributed computing architecture that connects a network of computers to form an on-demand robust network. A network of computers utilizes grid computing to solve complex problems. In embodiments, a grid system uses many computers in different locations. These computers are connected to complete a specific task or process.

The computers in a grid work together to perform a task. Additionally, each computer performs a part of the task. When a computer finishes a part of the task, it passes the rest of the work on to another computer. Further, grid computing contains a large number of servers and computers.

In an embodiment, a remote computing environment is a virtual machine, a virtual container, or a docker container.

In an embodiment, a remote computing environment is a physical computer.

In an embodiment, a remote computing environment is a combination of any number of virtual machines or physical computers.

A computing environment may also include additional elements such as software libraries, configuration files, connection parameters, or instructions.

In an embodiment, the remote environment configuration comprises a type of an operating system, e.g., Windows or Linux, a version of the operating system, a configuration file, a particular version of a library or other computer software, or a connection string comprising, for example, a username, a password, as well as connection parameters, to a data source, other remote computing environment, the meta-version tracking system, other elements of the computational system or other elements on the network.

Different elements of the computational system can be located remotely, and only certain elements can require deployment to a remote computing environment.

In an embodiment, at least two different elements of the computational system are deployed to two different remote computing environments.

Some computational systems use multi-step processes to achieve the result. In an embodiment, a second step of a process uses the output of a first step as input. In another embodiment, two steps are executed concurrently.

Systems and methods save and execute a set of instructions in the remote computing environment that executes steps in a particular matter. In embodiments, some steps can be executed concurrently while other steps depend on the successful completion of earlier steps.

In an embodiment, the set of instructions processes exceptions or failed states of certain dependent steps, either internal or external.

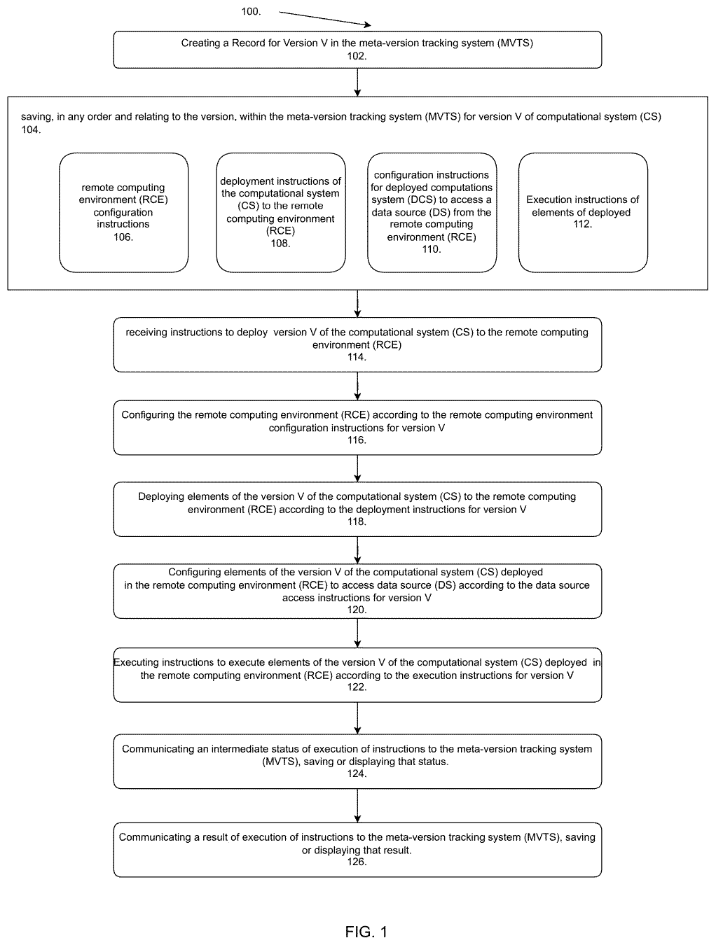

Referring to FIG. 1, a flowchart of a method 100 of automatically obtaining a result of execution of a version of a computational system on a remote computing environment is depicted, according to an embodiment.

A record is created at 102 that corresponds to a version V in a meta-version tracking system (MVTS) comprising a label for the version V and placeholders for the information about at least one component that needs execution on the remote computing environment (RCE), for example, location of the source code, source code compilation instructions, location of a database, connection information comprising address, authentication, or script, or identification of a virtual machine template, as well as instructions to configure a remote computing environment (RCE) 106, instructions to deploy elements of a computing system (CS) to the remote computing environment (RCE) 108, instructions to configure deployed elements of the computing system (CS) to access a data source (DS) 110, as well as execution instructions for execution of elements of the computing system (CS) in the remote computing environment (RCE) 112.

At 104 information is saved to the meta-version tracking system (MVTS) related to the version V that comprise instructions to configure a remote computing environment (RCE) 106, e.g., a location of a virtual machine template, a startup script, application deployment instructions; instructions to deploy elements of a computing system (CS) to the remote computing environment (RCE) 108, e.g., a script comprising instructions to copy a database to the remote computing environment (RCE), a location of an executable file created to perform the configuration; instructions to configure deployed elements of the computing system (CS) to access a data source (DS) 110, e.g., a script that copies a database access configuration file; as well as execution instructions for execution of elements of the computing system (CS) in the remote computing environment (RCE) 112, e.g., a shell script, a batch script, or a custom script that describes the computational dependencies between deployed elements.

In an embodiment, the source code or the binary code of elements of the computational system (CS) are also preserved within the multi-version tracking system. In an embodiment, the deployment instructions include references to the source code or binary code preserved within the meta-version tracking system (MVTS).

In an embodiment, the source code or the binary code of elements of the computation system (CS) are located in a version tracking system or a source code repository outside of the multi-version tracking system (MVTS).

In an embodiment, the source code or the binary code of elements of the computational system (CS) are stored within a file storage system on LAN or the Internet.

At 114 an instruction is received to deploy and execute version V of the computational system (CS).In an embodiment, a scheduler sends the instruction to deploy and execute version V. In an embodiment, this instruction is caused by a user input, for example, pressing a button, typing a command or clicking a button on a computer screen.

At 116 a set of configuration instructions from the meta-version tracking system is used to configure the remote computing environment.

In an embodiment, the remote computing environment comprises a virtual machine. In an embodiment, configuration instructions comprise instantiating a virtual machine from a template.

In an embodiment, the configuration instructions comprise deploying software libraries or software components.

In an embodiment, the configuration instructions comprise deploying files such as configuration files, training sets for neural networks, or other files that can be used by the elements of the computing system (CS) or other components that interact with these elements.

At 118 components of version V of the computational system (CS) are deployed to the remote computing environment (RCE). In an embodiment, a component of version V comprises a computer program in executable form, e.g., a script or a compiled program in machine code. In an embodiment, a component of version V comprises a file, e.g., a configuration file or a source code file. In an embodiment, a component of version V comprises a database or other collection of information.

In an embodiment, at least one component is compiled from source code before deployment.

In an embodiment, at least one component is deployed with a data source.

At 120 at least one deployed element of the computational system (CS) is configured to access a data source according to the instructions preserved in the meta-version tracking system (MVTS).

In an embodiment, a data source is located remotely, and configuration instructions comprise connection information.

In an embodiment, configuration instructions comprise the URL of a data source, authentication method, a username, or a password to connect to the system hosting the data source.

In an embodiment, the data source is located within the remote computing environment (RCE), for example, a database management server that hosts a database. That database is not copied, but rather referenced in its original location. This embodiment represents, for example, a scenario when the size of the data is prohibitively large in terms of storage size, transfer time, or processing power to make a copy of it at a different location.

In an embodiment, the data source is transferred to the remote computing environment (RCE) during the remote computing environment (RCE) configuration or computational system (CS) deployment steps, for example, the entire database in a form of files comprising the records of that database is copied or moved to the remote computing environment from its original location.

At 122 execution instructions are executed on the remote computing environment (RCE).

In an embodiment, execution instructions instruct different deployed components of the computing system (CS) to execute simultaneously, for example, to perform decompression, decryption, or other conversion operation operations on distinct collections of files thus preparing them for further processing.

In an embodiment, execution instructions instruct different deployed components of the computing system (CS) to use the output of one execution step as the input for another step, for example, component A receives medical data and anonymizes the medical data by replacing all units of personally identifiable information with their respective hash values and saves the resulting database at a different location accessible to the component B, wherein the component B uses the anonymized database to perform statistical analysis on the data stored within that database.

In an embodiment, a connection is established between a deployed component and another component of the computing system, e.g., with a remotely located database, or an API gateway. Execution instructions instruct different deployed components of the computing system (CS) to establish a connection with other components of the computing system (CS) running in the same or in a different remote computing environment (RCE). These instructions can include the address of the other component, e.g., an v4 or a v6 IP address, a port, a Universal Naming Convention (UNC), a Uniform Resource Locator (URL), as well as authentication information, e.g., a username, a password, a location of a cryptographic certificate, or a script that is executed to complete the process of establishing a connection.

At 124 an intermediate status of execution of at least one of the deployed elements of the computational system (CS) is communicated to the meta-version tracking system (MVTS), where it is saved or output to an output device such as a computer screen.

In an embodiment, data from the intermediate state is used to calculate a value related to the forecast of execution of the set of execution instructions such as time left, estimated time of completion, or percentage completed.

At 126 a result of execution of at least one of the deployed elements of the computational system (CS) is communicated to the meta-version tracking system (MVTS), where it is saved, for example, a number, a text string, a database, or a location of a file, a database, a URL, or a UNC or output to an output device such as a computer screen, for example, a status expressing a percentage of work completed is output to a computer screen, an email is sent with the timestamp of the beginning or end of execution of a particular step or element, or a system event is recorded indicating at least one parameter related to the status of the execution of the computational system.

In an embodiment, the execution instructions result in production of more than one result. At least one of these results is communicated to the meta-version tracking system (MVTS), where it is saved or output to an output device such as a computer screen or file in local or remote file system, or inside RCE.

In an embodiment, the result of execution of execution instructions is a number, a collection of numbers, a database, a document, an image, a video, a sound file, script, computer program, or another set of digital data.

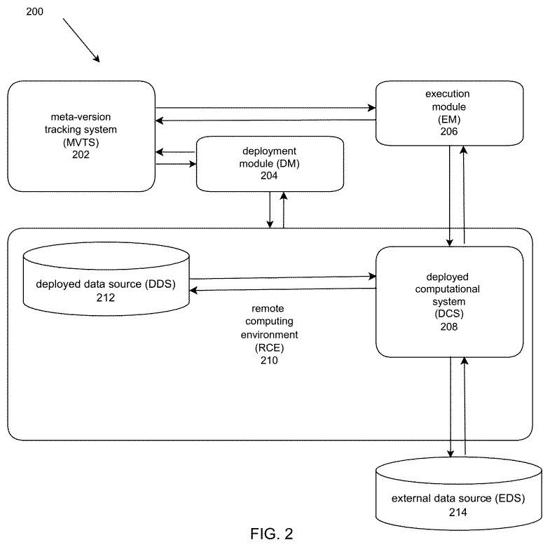

Referring to FIG. 2, a block diagram of a system for automatically obtaining a result of execution of a version of a computational system on a remote computing environment is depicted, according to an embodiment.

As illustrated, the system 200 comprises three components: a meta-version tracking system (MVTS) 202, a deployment module (DM) 204, and an execution module (EM) 206. Though not depicted, system 200 can be implemented by at least one processor and memory operably coupled to the at least one processor, and instructions to implement the MVTS 202, DM 204, and EM 206. The presence of the DM 204 allows the system 200 to automatically deploy and configure the exact version of the computational system on a sufficiently similar remote computing environment, while the presence of the EM allows the system of the invention to automatically execute the computational system, obtain the result of that execution and communicate the result to MVTS 202 thus verifying the previously obtained result. In an embodiment, DM 204 is configured to communicate directly to EM 206 for example, to indicate the fact that the deployment procedure is completed or to convey the command to initiate the execution process.

The meta-version tracking system (MVTS) 202 is configured to receive, save, and output instructions related to a particular version V of the computational system, as well as intermediate statuses and execution results.

Specifically, the meta-version tracking is configured to receive, save, and output at least one configuration instruction for at least one element of the remote computing environment (RCE), at least one deployment instruction for at least one element of the computational system (CS) to the execution module (EM) 206, at least one configuration instruction for at least one element of the deployed computational system (DSC) 208 to access at least one data source (DS), at least one intermediate status of execution of at least one element of the version V of the computational system (CS) in the remote computing environment (RCE) 210, and at least one intermediate result (R) of execution, for example, percentage completed or estimated time remaining, or number of records created, of at least one element of the version V of the computational system (CS) in the remote computing environment (RCE) 210.

In an embodiment, the remote computing environment (RCE) 210 is a virtual machine, a virtual container, a docker container, a high-performance computing cluster (HPC), a physical computer, or a combination of these elements.

In an embodiment of an HPC cluster, HPC utilizes massively parallel computing to run multiple tasks simultaneously on multiple computer servers or processors. Massively parallel computing is parallel computing using tens of thousands to millions of processors or processor cores. Further, HPC uses computer clusters (also called HPC clusters). An HPC cluster includes multiple high-speed computer servers networked together, with a centralized scheduler that manages the parallel computing workload. The computers, called nodes, use either high-performance multi-core CPUs or, more likely today, GPUs (graphical processing units), which are well suited for rigorous mathematical calculations, machine learning models and graphics-intensive tasks. A single HPC cluster can include 100,000 or more nodes. Further, HPC uses high-performance components: All the other computing resources in an HPC cluster-networking, memory, storage and file systems-are high-speed, high-throughput and low-latency components that can keep pace with the nodes and optimize the computing power and performance of the cluster.

In an embodiment, the meta-version tracking system (MVTS) 202 is further configured to receive, save, and output source code or binary code of at least one element of the computational system (CS).

In an embodiment, the meta-version tracking system (MVTS) 202 is further configured to receive, save, and output data from a data source (DS).

In an embodiment, the meta-version tracking system (MVTS) is further configured to receive, save, and output a virtual machine template that can be used as a remote computing environment. A virtual machine template is a copy of a virtual machine that can be used to create and provision new virtual machines. Typically, a template includes an installed guest operating system and a set of applications.

The deployment module (DM) 204 is configured to configure the remote computing environment (RCE) 210, deploy at least one component of the version V of the computation system (CS) to the remote computing environment (RCE) 210, and configure at least one element of the version V of the deployed computational system (DCS) to access at least one data source (DS) to prepare the deployed computational system (CDS) 208 for use. In an embodiment, the configuration of the remote computing environment comprises installing a program at a remote computer, instantiating a VM from a VM template, or running a configuration script.

In an embodiment, the remote computing environment comprises computer hardware, operating system, and a plurality of installed programs, libraries, or copied files. In an embodiment, the DM makes a modification to the RCE by installing an additional program or library or by modifying, creating, moving, or copying a file, for example, a configuration file. Some operating systems, for example, different versions of Microsoft Windows, have an additional configuration storage element called “registry” that stores certain program settings. In an embodiment, the DE modifies the registry on at least one of the physical or virtual computers within the RCE.

In an embodiment, the deployment module (DM) is further configured to download a component necessary for the configuration of the remote computing environment (RCE) from the Internet.

In an embodiment, the deployment module (DM) 204 is further configured to compile at least one component of the computational system (CS) or an external component from source code.

In an embodiment, the deployment module (DM) 204 is configured to instantiate a virtual machine or a virtual container from a template.

In an embodiment, the deployment module (DM) 204 is configured to establish a connection from the connection from the meta-version tracking system (MVTS) 202 to the remote computing environment (RCE) 210.

In an embodiment, the result of the execution of the deployment module (DM) 204 is a configured remote computing environment (RCE) 210 with deployed computational system (DCS) 208, wherein the deployed computational system (DCS) 208 has access to the data source (DS).

In an embodiment, the deployment module (DM) 204 deploys at least one element of the data source (DS) that was either stored within the meta-version tracking system (MVTS) 202 or to the remote computing environment (RCE) 210 by creating a copy of that element. The deployed at least one element becomes a part of the deployed data source (DDS) 212. In an embodiment, the deployment module (DM) 204 is configured to update at least one element of the deployed computational system (DCS) 208, for example, by creating or changing a registry key value or by creating or editing a name/value pair in a configuration file to comprise, for example, a URL or a connection string, to allow the deployed computational system (DCS) 208 to access that element of the deployed data source (DDS) 212. In that embodiment an additional configuration step is needed to ensure that the location, for example, UNC or URL, or connection data, for example, username, password, or certificate location, of the deployed data source (DDS) in relationship to the deployed computational system (DCS) are reflected correctly. For example, the UNC path to the deployed data source (DTS) 212, for example, a file-based database, may include a name of a computer that is specific to the remote computing environment (RCE), and the UNC path of that file needs to be communicated to the deployed computational system (DCS) 208 in order for the deployed computational system (DCS) 208 to be able to access that deployed data source (DTS) 212.

In another embodiment, the deployed computational system (DCS) uses an external data source (EDS) 214. In that embodiment, the deployment module (DM) 204 is configured to update at least one element of the deployed computational system (DCS) 208, for example, by creating or changing a registry key value or by creating or editing a name/value pair in a configuration file to comprise, for example, a URL or a connection string, to allow the deployed computational system (DCS) 208 to access that element of the deployed data source (EDS) 214. In that embodiment an additional configuration step is needed to ensure that the location, for example, UNC or URL, or connection data, for example, username, password, or certificate location, of the deployed data source (DDS) in relationship to the deployed computational system (DCS) are reflected correctly. For example, additional gateway settings may be needed to access a database management system or a database server hosted by one organization from the deployed computational system (DCS) 208 hosted by another organization.

In an embodiment, the deployment module (DM) 204 is configured to test the status of a connection from the meta-version tracking system (MVTS) 202 to the remote computing environment (RCE). In an embodiment, the test is performed by sending a ping request to the expected IP address corresponding to the remote computing environment (RCE) 210. In another embodiment, an attempt is made to establish a connection with a component expected to be configured to accept a connection at the remote computing environment (RCE) 210, for example, a database server.

In an embodiment, the deployment module (DM) 204 is further configured to report the result of that test to the meta-version tracking system (MVTS) 202 that saves it to outputs to an output device such as a computer screen.

In an embodiment, the deployment module (DM) 204 is configured to test the status of a connection of at least one component of the computational system (CS) deployed to the remote computing environment (RCE) 210 to a data source (DS). In an embodiment, the deployment module (DM) is further configured to report the result of that test to the meta-version tracking system (MVTS) 202 that saves it to outputs to an output device such as a computer screen, or file in local or remote file system, or inside the remote computing environment (RCE) 210.

The execution module (EM) 206 is configured to execute at least one element of the version V of the deployed computational system (DSC) 208 in the remote computational environment (RCE) 210, receive at least one intermediate status from at least one running element of the version V of the deployed computational system (DCS) 208 and communicate it to the meta-version tracking system (MVTS) 202 or output it to an output device such as a computer screen, and receive at least one result R from the execution of at least one element of the version V of the deployed computational system (DCS) 208 and transfer it to the meta-version tracking system (MVTS) 202.

In an embodiment, the execution module (EM) 206 is further configured to calculate at least one intermediate status of execution of at least one element of the version V of the deployed computational system (DSC) 208 further comprises calculating at least one parameter corresponding to the forecast of execution, such as time left or percentage completed, and saving it to the meta-version tracking system (MVTS) 202 or outputting it to an output device such as a computer screen. In an embodiment, that forecast is provided to system operators to make decisions on project management such as resource allocation. In another embodiment, these parameters are used in planning execution of future versions of the project that use some of the same or similar components.

In an embodiment, the execution module (EM) 206 is configured to receive more than one result R from the execution of at least one element of the version V of the deployed computation system (DCS) 208 and transfer them to the meta-version tracking system (MVTS) 202.

In an embodiment, the meta-version tracking system (MVTS) 202 is further configured to display a report depicting correlation of variances in the computational system or a data source in different versions to the results in corresponding versions.

In an embodiment, the meta-version tracking system (MVTS) 202 is configured to receive at least one intermediate status of execution of at least one element of the version V of the deployed computational system (DSC) 208 that further comprises calculating at least one parameter corresponding to a forecast of execution, such as time left or percentage completed, and saving it to the meta-version tracking system MVTS or outputting it to an output device such as a computer screen. Availability of such status allows the operator of the system to perform staff and resource scheduling as well as further planning.

1. A method of obtaining a result R of execution of a version V of a computational system CS on a remote computing environment RCE using instructions saved within a meta-version tracking system MVTS, wherein R comprises at least one numeric value, CS comprises a binary executable or a scripting file, RCE comprises at least one physical or virtual computer that comprises physical or virtualized computer hardware and an operating system, the method comprising:
creating a record within the meta-version tracking system MVTS related to a version V;
recording, in any order, in the meta-version tracking system MVTS related to the version V within the record:
at least one configuration instruction for at least one element of the remote computing environment RCE,
at least one deployment instruction for at least one element of the computational system CS to an execution environment EE,
at least one configuration instruction for at least one element of the deployed computational system DSC to access at least one data source DS,
at least one instruction to execute at least one element of a deployed computational system DSC in the remote computing environment RCE;
receiving a command to deploy and execute the version V of the computational system CS to the remote computing environment RCE;
modifying at least one element of the remote computing environment using at least one instruction saved in the meta-version tracking system MVTS related to the version V;
copying at least one element of the version V of the computational system CS to the remote computing environment RCE using at least one instruction saved in the meta-version tracking system MVTS related to the version V;
configuring at least one element of the deployed computational system DCS to access at least one data source DS using at least one instruction saved in the meta-version tracking system MVTS related to the version V;
executing using at least one instruction in the meta-version tracking system MVTS to execute at least one element of the version V of the deployed computational system DSC in the remote computing environment RCE;
receiving at the meta-version tracking system MVTS at least one intermediate status of execution of at least one element of the version V of the deployed computational system DSC and saving the at least one intermediate status within the meta-version tracking system MVTS or outputting the at least one intermediate status to an output device such as a computer screen;
saving within the remote computing environment RCE at least one result R of the execution of at least one element of the version V of the deployed computational system DSC in the remote computing environment RCE; and
transferring at least one result R from the remote computing environment to the meta-version tracking system and saving the at least one result R within the system to indicate that the at least one result R is related to the meta-version V of the computational system CS.

2. The method of claim 1, wherein the remote computing environment is a virtual machine, a virtual container, a docker container, or a grid node.

3. The method of claim 2, wherein the configuration of a virtual machine comprises instantiating the virtual machine from a template, a virtual container, a docker container, or a grid node.

4. The method of claim 1, wherein the remote computing environment comprises a high-performance computing (HPC) cluster.

5. The method of claim 1, wherein the configuration of the remote computing environment RCE comprises installation of programs or components.

6. The method of claim 1, wherein the configuration of the remote computing environment RCE comprises copying files to the remote computing environment RCE.

7. The method of claim 1, wherein the data set DS exists outside of the remote computing environment RCE.

8. The method of claim 1, wherein the at least one configuration instruction for at least one element of the remote computing environment RCE comprises at least one instruction on how to establish a network connection from the meta-version tracking system MVTS to the remote computing environment RCE for direct deployment of components from the meta-version tracking system MVTS to the remote computing environment RCE.

9. The method of claim 1, wherein the at least one configuration instruction for at least one element of the deployed computational system DSC to access at least one data source DS comprises at least one instruction on establishing a network connection between the element and the data source DS.

10. The method of claim 1, wherein receiving at the meta-version tracking system MVTS at least one intermediate status of execution of at least one element of the version V of the deployed computational system DSC further comprises calculating at least one parameter corresponding to a forecast of execution, such as time left or percentage completed, and saving the at least one parameter to the meta-version tracking system MVTS or outputting the at least one parameter to an output device such as a computer screen.

11. A system of obtaining a result R of executing a version V of the computational system CS on a remote computing environment RCE using instructions saved within a meta-version tracking system MVTS, the system comprising:
a meta-version tracking system configured to:
create a record for the version V of the computational system VS;
receive, save, and output:
at least one configuration instruction for at least one element of the remote computing environment RCE,
at least one deployment instruction for at least one element of the computational system CS to an execution environment EE,
at least one configuration instruction for at least one element of a deployed computational system DSC to access at least one data source DS,
at least one intermediate status of execution of at least one element of the version V of the computational system CS in the remote computing environment RCE, and
at least one intermediate result R of execution of at least one element of the version V of the computational system CS in the remote computing environment RCE;
a deployment module configured to:
using at least one instruction from the meta-version tracking system MVTS, configure the remote computing environment RCE,
using at least one instruction from the meta-version tracking system MVTS, deploy at least one component of the version V of the computation system CS to the remote computing environment RCE, and
using at least one instruction from the meta-version tracking system MVTS, configure at least one element of the version V of the deployed computational system DCS to access at least one data source DS; and
an execution module configured to:
using at least one instruction from the meta-version tracking system MVTS, execute at least one element of the version V of the deployed computational system DSC in the remote computational environment,
receive at least one intermediate status from at least one running element of the version V of the deployed computational system DCS and communicate the at least one intermediate status to the meta-version tracking system or output the at least one intermediate status to an output device such as a computer screen, and
receive at least one result R from the execution of at least one element of the version V of the deployed computational system DCS and transfer the at least one result R to the meta-version tracking system MVTS.

12. The method of claim 11, wherein the remote computing environment is a virtual machine, a virtual container, a docker container, or a grid node.

13. The method of claim 12, wherein the configuration of a virtual machine comprises the step of instantiating that virtual machine from a template, a virtual container, a docker container, or a GRID node.

14. The method of claim 11, wherein the remote computing environment comprises a high-performance computing cluster HPC.

15. The method of claim 11, wherein the configuration of the remote computing environment RCE comprises installation of programs or components.

16. The method of claim 11, wherein the configuration of the remote computing environment RCE comprises copying files to the remote computing environment RCE.

17. The method of claim 11, wherein the data set DS exists outside of the remote computing environment RCE.

18. The method of claim 11, wherein the at least one configuration instruction for at least one element of the remote computing environment RCE comprises at least one instruction on how to establish a network connection from the meta-version tracking system MVTS to the remote computing environment RCE.

19. The method of claim 11, wherein the at least one configuration instruction for at least one element of the deployed computational system DSC to access at least one data source DS comprises at least one instruction on establishing a network connection between the element and the data source DS.

20. The method of claim 11, wherein receiving at the meta-version tracking system MVTS at least one intermediate status of execution of at least one element of the version V of the deployed computational system DSC further comprises calculating at least one parameter corresponding to a forecast of execution, such as time left or percentage completed, and saving the at least one parameter to the meta-version tracking system MVTS or outputting the at least one parameter to an output device such as a computer screen.
